(19) United States
(12) Patent Application Publication
(10) Pub. No.: US 2010/0268489 A1
(43) Pub. Date: Oct. 21, 2010

(54) METHOD AND SYSTEM FOR REGISTERING AND MEASURING LEAKS AND FLOWS

(76) Inventors: Terje Lennart Lie, Garnes (NO); Gunnar Andersen, Mathopen (NO); Geir Instanes, Nesttun (NO)

Correspondence Address: Francis C. Hand;Carella, Byrne, et al, 5 Becker Farm Road, Roseland, NJ, 07068-1739, US

(21) Appl. No.: 12/734,088

(22) PCT Filed: Oct. 10, 2008
(86) PCT No.: PCT/NO2008/000363

§ 371 Date: Jun. 22, 2010

(30) Foreign Application Priority Data
Oct. 10, 2007 (NO) 20075183

(51) Int. Cl. G01M 3/24

(52) U.S. Cl. 702/51

(57) ABSTRACT

The present invention concerns a method of quantifying, detecting and localizing leaks or flows of liquid, gasses, or particles, in an oil or gas producing well (230). The method utilizes an acoustic transducer (150) arranged in the well (230). The method comprises steps of: (a) detecting signals (210) using the transducer (150), wherein the signals (210) are generated by acoustic noise from leaks (20) or flow of liquid, gasses, or particles in surroundings of the transducer (150); (b) amplifying the signals (210) to generate corresponding amplified signals for subsequent processing in a processing unit (170) disposed locally to the transducer (150); (c) filtering the amplified signals (210) over several frequency ranges using dynamic filtering for simultaneously detecting in these frequency ranges for better optimizing the signal-to-noise ratio by filtering away background noise in the amplified signals (210), and thereby generating corresponding processed data; and (d) sending the processed data from the processing unit (170) to a unit on the surface for storage and/or viewing of said data. The invention also comprises a corresponding system for implementing the method. The method and system are beneficially adapted for a continuous measurement up and/or down the oil or gas producing well. (230) in a non-stepwise manner.

### TECHNICAL FIELD OF THE INVENTION

The present invention relates to methods of registering and measuring leaks and flows. Moreover, the invention concerns measuring systems operable to utilize aforesaid methods. Furthermore, the invention also relates to methods of using passive acoustic transducers in various spatial configurations and connections for detecting and localizing leaks and micro flows of liquids, gasses or particles in, or in connection with, oil- and/or gas-producing wells. Such measuring systems comprise logging tools which are lowered in operation down into wells by means of corresponding wires or coil pipes, the logging tools being utilized alone or as part of a logging string.

### BACKGROUND OF THE INVENTION

Leaks in oil- and/or gas-producing wells potentially cause serious problems for operators, both with regard to safety and economics. Such leaks may in principle occur anywhere where there is a barrier between two volumes when a pressure difference exists in operation between the two volumes. Such leaks may for example arise:
(a) in a borehole casing during drilling;
(b) in a production pipe during oil and/or gas production;
(c) in a production pipe during its installation; and
(d) during testing of other mechanisms, for example testing gas lift valves.

When a leak arises, there are many important reasons for correcting the leak. The reasons include:
(i) avoiding total loss of control of a well in which the leak has arisen;
(ii) preventing corrosive fluids from harming a borehole casing in which the leak has arisen; and
(iii) delaying a complete workover of the well as a consequence of the leak.
   By correcting such leaks, operators may potentially save considerable costs.

A published British patent application no. GB 2 367 362A discloses a system including two broadband receivers located in mutually different spatial positions. Sensors included in the receivers are optionally accelerometers or hydrophones. When the two receivers are positioned in operation relative to a leak, electrical signals generated by the receivers in response to receiving a general acoustic noise energy from the leak are analyzed for characterizing the leak.

Such analysis involves dividing the electrical signals into frequency bands. Moreover, such analysis is based upon temporal periods for the acoustic noise energy to propagate from the leak to the two broadband receivers. The system is employed principally in water pipes, but is susceptible to being optionally utilized in other fluid-conducting pipelines, for example where these pipelines are buried below ground level. Moreover, the system depends upon generation of acoustic noise energy at a relatively low frequency, in order for the noise energy to be able to propagate over relatively larger distances, for example in a range of 50 to 100 meters, from the leak to the two receivers. In order to process the two electrical signals from the receivers, a cross correlation computation is employed to determine a difference in arrival time for the two signals, and thus to determine from the arrival time a spatial localization of the leak.

In order to determine a magnitude of the leak, four alternative methods are described in the aforementioned British patent application. In the system, the two broadband receivers are operable to detect the acoustic noise energy from the leak, wherein the noise energy is divided across several frequency bands after detection. By cross-correlating the received signals, a correlated signal is computed having an amplitude proportional to an effect of the signals, wherein the effect is related to a magnitude of the leak. Different statistical methods are optionally employed, such methods taking into account a size of a pipeline, and a type of material employed to construct the pipeline. In a first such method, a magnitude of the leak is computed from a pressure different present across the leak. In a second such method, amplitude characteristics are computed, wherein a square root of a cross correlation function is employed in such computation. In a third such method, use is made of so-called classification parameters, for example a Naïve Bayes, “Decision Tree”, or vector/nucleus based classification parameters. In a fourth such method, a relationship between individual components or groups of components in the effect or amplitude characteristics is identified. Alternatively, the system optionally uses neural networks with noise levels, pipeline type, pressure differences and similar being used as initial values, with the magnitude of the leak, divided into several magnitude levels, as output values:

Moreover, in a published international PCT patent application no. WO 98/50771, there is disclosed a method of digitalizing registered data prior to sending the data for processing in a data processor unit. The method utilizes two mounted sensors, for example accelerometers, hydrophones or microphones. Optionally, the sensors are used on each side of, and at a relatively large distance from, a leak. A time required for acoustic energy to propagate from the leak to the sensors is found in order to localize the leak, and cross-correlation is used to determine the magnitude of the leak. The measurements registered by the sensors are sent in analogue form by cable to a remote signal processing unit. In the signal processing unit, the measurements are digitalized and transferred to a microcontroller which is operable to compress packages of data for wireless transferral to a receiving station, which may be placed very remotely from the signal processing unit. In addition, there are described methods of signal processing and associated calculating algorithms operable to determine results for presentation.

In a published United States patent application no. US 2002124633, there is disclosed a method of, by filtration, finding the connection of patterns for real-time acoustic noise, in order to detect and localize leaks in a pipeline. The method includes steps of finding a pressure wave, and differentiating noise generated by a leak associated with the pressure wave from background noise. The method involves a step of finding the background noise beforehand in a normal non-leak situation, wherein the noise generated from the leak is differentiated from the background noise. Mounted sensors are used to receive the real-time acoustic noise generated within a pipeline, and the data processors are situated at several positions along the pipeline for processing signals generated by the mounted sensors, and data from these data processors are used collectively in a central node in order to spatially locate the leak.

In a published Canadian patent application number CA 1141019, there is disclosed a method of localizing a leak by using two passive acoustic transducers placed on each side of the leak in order to, through correlation of received noise, find a spatial location of the leak. Optionally, more than two transducers are used in order to implement the method. The transducers are optionally placed spatially randomly in relation to the leak, for example on both sides of the leak or on one side of the leak. In addition, the transducers optionally have different transducing characteristics. Techniques as described in the foregoing for determining a spatial location of the leak are mainly utilized.

In a published patent no. JP4081633, there is described a method of detecting the presence of a leak but not necessarily the localization thereof. The method employs an acoustic transducer where a noise profile is measured and then compared with an earlier measured noise profile characteristic for normal conditions; the earlier measured noise profile characteristic corresponds to natural background noise. The method includes a step of subtracting the measured signal from the background noise.

In a published international PCT patent application no. WO2004104570, there is described a system for detecting leaks in underground gas pipelines by the aid of two acoustic transducers. A first of the traducers is placed in a fixed position above, or at a certain distance from, a gas pipeline. A second of the transducers is placed successively in a plurality of positions above the pipeline. Output signals generated by the transducers are measured for all the positions to the second transducer, and the signals are filtered to remove background noise. If there is a maximum value for a difference between the measured noise and the background noise, such a maximum value determines the presence and position of a leak.

A technical problem encountered in respect of the aforementioned known methods is that they are at least one of:
(a) too time consuming;
(b) require large amounts of computational effort;
(c) are not able to adequately distinguish when more than one type of leak is substantially spatially coincident with another type of leak, for example in a vicinity of a complex fracture of a casing;
(d) insufficiently precise when spatially detecting leaks, and/or insufficiently sensitive to identify virtually every leak in a well.

The present invention seeks to address one or more of these problems encountered when utilizing known contemporary methods of leak detection, for example as elucidated in the foregoing.

### SUMMARY OF THE INVENTION

An object of the present invention is to increase the precision of detection, and to localize virtually every leak in wells, pipelines and similar.

A further object of the invention is to provide methods of signal processing for detecting leaks in wells which are less computationally intensive and thereby, for a given computing capacity, enable more rapid detection of leaks in wells.

In accordance with a first aspect of the invention, there is provided a method as defined in appended claim 1: there is provided a method of quantifying, detecting and localizing one or more leaks or a flow of liquid, gasses, or particles, in an oil or gas producing well, wherein the method employs at least one acoustic transducer deployed in operation in the well, characterized by that the method comprises steps of:
(a) detecting one or more signals using the at least one acoustic transducer, wherein the one or more signals are generated by acoustic noise from one or more leaks or flow of liquid, gasses, or particles in a region surrounding the at least one transducer;
(b) amplifying the one or more signals to generate one or more corresponding amplified signals for inputting into a processing unit local to the at least one transducer;
(c) filtering the one or more amplified signals over several frequency ranges by utilizing dynamic filtering for improving signal-to-noise ratio by filtering away background noise in the one or more amplified signals, thereby generating corresponding filtered data; and
(d) processing the filtered data in the processing unit for transmitting the filtered data to a unit including a computer in a surface region remote from the at least one acoustic transducer for storage and/or viewing of the filtered data, the computer being adapted to perform simultaneous resolution of the filtered data to identify occurrence of the one or more leaks or a flow of liquid, gasses, or particles, in an oil or gas producing well.

There invention is of advantage in that dynamic filtering by dividing of the receiving signals into several frequency ranges makes it possible to better optimise the signal-to-noise ratio for isolating signal components representative of leaks or flows from the background noise.

Optionally, the method includes a step of computing a physical size of the one or more leaks from a pressure difference (ΔP) existing in operation across a wall of a pipe in which the one or more leaks have arisen and an amplitude of the one or more signals provided by the at least one transducer. Being able to determining a leak size from a pressure difference (ΔP) in Combination with amplitude detection of an acoustic signal derived from the leak without primarily considering spatial positioning of the at least one acoustic transducer relative to the leak is an unexpected result.

Optionally, the method involves transmitting the filtered data at a data rate of up to 1 kbit/second from the processing unit along a wire connection of a string to the computer in the surface region remote from the at least one acoustic transducer. In comparison to other known system for characterizing defects employing high bandwidth digital communication links, the present invention is capable of implemented and worked with more modest bandwidth requirements, thereby potentially reducing equipment cost and enhancing equipment reliability. More optionally, when implementing the method, the wire connection is in a range of 3 to 10 km long.

Preferred embodiments of the invention implemented as a method are defined in the dependent claims 2 to 14.

Optionally, when implementing the method, the at least one acoustic transducer is mounted inside a sensor housing adapted to be continuously lowered or raised in operation down or up into the well or a pipe by utilizing a string to support the at least one acoustic transducer. Continuous lowering or raising the at least one acoustic transducer is important in the content of the present invention and surprisingly generates quite different technical measurement results in comparison to a stationary or stop/start manner of measurement performed by the at least one acoustic transducer.

Optionally, when implementing the method, data collection occurs concurrently with the at least one transducer being in continuous motion up or down the well or pipe with a logging speed in a range of 0.1 to 50 meters per minute.

Optionally, when implementing the method, the processing unit is operable to process the one or more amplified signals in real time during data logging.

Optionally, the method is adapted to characterize the well implemented as an injection well for gas and water.

Optionally, the method is adapted to detect and localize a secondary leak, the secondary leak being a leak and flow of gas, liquid, or particles, in a position further out from the well, namely in a distantly-positioned casing room.

Optionally, the method is adapted to detect and localize a leak in the well during operation or shutdown of the well.

Optionally, the method is adapted to measure small flows of oil, water, or gas, or a combination of these in a casing room close to a position of the at least one acoustic transducers.

Optionally, the method is adapted to measure particles in small flows of oil, water, or gas, or a combination of these in a production zone close to a position of the at least one acoustic transducers.

Optionally, the method is adapted to implement fluid measurements while the well or the pipe is operational or during shutdown.

Optionally, the method involves using a logging string or a tool for the at least one transducer that is continuously in motion when in operation in the well, or a pipe with log speeds in a range of 0.1 to 50 metres per minute, for carrying out measurements whilst the well or pipe is operational or during shutdown.

According to another aspect of the invention, a system is provided as defined in appended claim 15, and preferred embodiments are defined by dependent claims 16 to 28.

According to a second aspect of the invention, there is provided a system for implementing a method of quantifying, detecting, or localizing one or more leaks or a flow of liquid, gasses, particles in an oil or gas producing well: there is provided a system for implementing a method of quantifying, detecting, or localizing one or more leaks or a flow of liquid, gasses, particles in an oil or gas producing well, wherein the system includes at least one acoustic transducer arranged in operation in the well, characterized by that the system comprises;
(a) a detector operable to detect one or more signals generated by the at least one acoustic transducer, wherein the one or more signals are generated in operation by acoustic noise from one or more leaks or flow of liquid, gasses, or particles in a surroundings of the at least one transducer;
(b) an amplification device arranged to amplify the one or more signals to generate corresponding one or more amplified signals, the system further comprising a processing unit local to the transducer for processing the one or more amplified signals;
(c) a filtering device associated with the processing unit for dividing the one or more amplified signals over several frequency ranges by applying in operation dynamic filtering, the filtering device being operable to simultaneously detect in the several frequency ranges for enhancing signal-to-noise ratio by filtering away background noise in the one or more amplified signals, and thereby generating corresponding processed data; and
(d) a communication link operable to send the processed data from the processing unit to a unit on a surface for storage and/or viewing of the processed data.

Optionally, in the system, the at least one acoustic transducer is mounted inside a sensory housing operable to be lowered down into the well or a pipe in a continuous manner whilst supported from a string.

Optionally, the system is operable to collect measurement data when the at least one transducer is continuously moved with a logging speed in a range of 0.1 to 50 metres per minute.

Optionally, in the system, the processing unit is arranged to carry out adaptive data processing in real time.

Optionally, the system is configured for the well implemented as an injection well for gas and water.

Optionally, the system is operable to detect and localize a secondary leak, the secondary leak being a leak and flow of gas, liquid, or particles, in a position further out in a well construction, in a distant casing room.

Optionally, the system is operable to detect and localize a leak in a well whilst the well is operational or during shutdown.

Optionally, the system is operable to measure small flows of oil, water, or gas, or a combination of these in a casing room in proximity of a position of the at least one transducer.

Optionally, the system is operable to measure small flows of oil, water, or gas, or a combination of these in a production zone in proximity of a position of the at least one transducer

Optionally, the system is operable to implement flow measurements while the well or pipe is operational or during shutdown.

Optionally, the system is arranged to use a logging string or a tool for the at least one transducer, the logging string being adapted for being in continuous motion in a well, or in a pipe with logging speeds in a range of 0.1 to 50 meters per minute, the system being operable to implement measurements whilst the well or pipe is operational or during shutdown.

According to a third aspect of the present invention, there is provided a software product recorded on a machine-readable data carrier, the software product being executable on computing hardware in connection with implementing a method pursuant to the first aspect of the invention.

According to a fourth aspect of the present invention, there is provided a software product recorded on a machine-readable data carrier, the software product being executable on digital signal processing hardware for processing one or more signals, the software product being executable on the signal processing hardware in connection with implementing a method pursuant to the first aspect of the invention.

The present invention as defined in the appended patent claims is capable of, with great accuracy, detecting and localizing virtually any leak in a well. An unwanted radial or axial flow of oil, water, particles or gas, or a mixture of these across a barrier, may thus be detected, localized, and thereafter corrected. The high sensitivity of the system and method makes it possible to detect leak volumes down to a few decilitres per minute, for example less than 100 decilitres per minute and more preferably less than 10 decilitres per minute, whilst simultaneously localizing a leak to within a few centimetres precision. The system works independently from the direction of the flows, and it provides a particularly advantageous feature that one may detect leaks in or nearby a casing, even if it is measured from a position inside an associated production pipe. Thus, the system is capable of detecting both particles and flowing liquids or gases in and by a flow point of a leak. A tool that is described in relation to the present invention may be driven down into the well during normal operation, both when produced and injected fluids are present.

In addition to detecting leaks in a cross section of the pipe construction, the present invention may also be used to detect leaks with very small fluid flows lengthwise along the well, for example within a casing.

The following description of the present invention comprises a method and a system for detecting leaks or flows of liquid, gasses, or particles by means of acoustic transducers. The invention is suited for measuring leaks or flows of fluid, gasses, or particles in connection with, for example a petroleum producing well in one or another phase of the process by complementing the well, or by production of oil or gas, or by use of the well for injecting gas or fluid into a reservoir. The tool is shaped as a closed pipe, a so called down hole “log tool”, which may be inserted into the well, for example by way of being supported on a wire or a coil pipe. Thus, the tool is localized in operation inside the pipe itself that is being used for production or injection of fluids during the measurements. The tool logs data continuously by utilizing one or more passive acoustic transducers that detect, that is “listens to”, the noise profile from the surroundings whereat the one or more transducers are localised at any point in time. This is done at the same time as the tool is guided through the pipe, in order to facilitate detection of a leak or flow when the tool is near the specific leak or flow, irrespective of the nature of the leak or flow. There will always be several different kinds of noise present, such as electrical, mechanic, or thermal noise, or noise from flowing mediums and possibly from the presence of particles like sand and other mechanical objects, which may be brought in contact with the structure. This noise, which exists in the normal conditions where there are no leaks present, is here called “background noise”. It will have its own special spectral characteristics, which may be detected, analysed, and saved prior to implementing the measuring process itself. A leak or flow of fluid or gasses or particles in the structure will, however, generate noise with a different characteristic than the background noise, as this noise will be localised in one or more specific frequency ranges, different from the frequency distribution of the background noise. Thus, the tool is specially designed to collect and process this information. The acoustic signals are locally and immediately digitised and processed inside of the tool itself, and then transferred to a suitable computer on the surface that stores and visually presents the results of the logging. The tool may thus give the operator information about even small leaks, as well the specific position of the leak in real time.

Features of the invention are susceptible to being combined in any combination without departing from the scope of the invention as defined by the accompanying claims.

### DESCRIPTION OF THE FIGURES

Embodiments of the present invention will now be described, by way of example only, with reference to following diagrams wherein:

FIG. 1 is a schematic illustration of a cross-section of a typical oil well and its associated components, wherein a logging tool is located inside the well, the logging tool being operatively suspended by a wire; in FIG. 1, a plurality of spatial points whereat leaks arise in processes of drilling, completing and production are shown;

FIG. 2 is a schematic illustration of a cross-section of the tool in FIG. 1 localized in a well; there is shown a sensor element implemented as a passive acoustic transducer that is connected to an amplifier whose parameters are set by a digital signal processor (DSP). Communication from this processor up to the surface is provided in operation via by a telemetric system and a cable built into the wire wherefrom the tool hangs in operation;

FIG. 3 is a schematic illustration of sub-signals and their respective Fourier components in respect of the present invention, the Fourier components of a given sub-signal being isolated with respect of Fourier frequency cu; and

FIG. 4 is a schematic illustration of sub-signals and their respective Fourier components in respect of the present invention, the Fourier components of a given sub-signal being overlapping with respect of Fourier frequency cc.

### DESCRIPTION OF EMBODIMENTS OF THE INVENTION

In summary, the present invention relates to a method of registering and measuring leaks and flows in a pipe by monitoring passive acoustic conditions in the pipe, for example in connection with oil and gas wells. The method utilizes one or more acoustic sensor elements to sense acoustic signals generated from several different acoustic sources arising within pipes and around pipes. The method differentiates the signals from each source through analysis. The invention also relates to a tool that comprises one or more acoustic sensor elements and a digital processing unit which operates within a pipe, and which may be moved continuously or stepwise in the longitudinal direction of the pipe.

Processes that partake as acoustic signal sources in a pipe may be:
(a) flow of fluids through the pipe;
(b) flow through leaks;
(c) annular flow in porous media in an external region outside the pipe;
(d) particles that hit the pipe wall or tool; and
(e) mechanical occurrences such as impacts and gliding between the tool and the pipe wall.

The received acoustic signals are transformed to one or more digital signals, and digital signal processing is carried out within the tool. A selection of the processed information is then sent onto a surface on the outside of the pipe for one or more of the following: storing the information, interpreting the information, and viewing the information.

A selection of data that is being sent from the tool, for example to the aforesaid digital processing unit, namely a computer, may be configured beforehand or during execution of measurements so that all the necessary information is available for interpretation in spite of limitations, such as the data transmission rate capacity of a communication line that is utilized between the tool and the computer.

Following this, the invention with be described in more detail regarding its manner of operation, its construction, with reference to details in the Figures mentioned above.

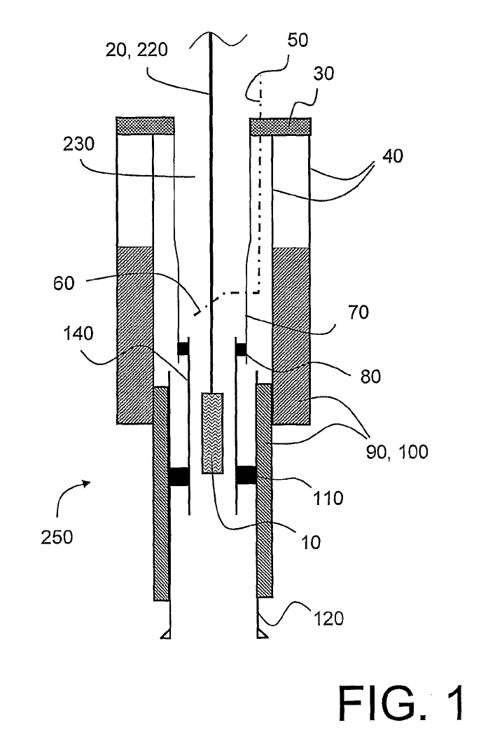

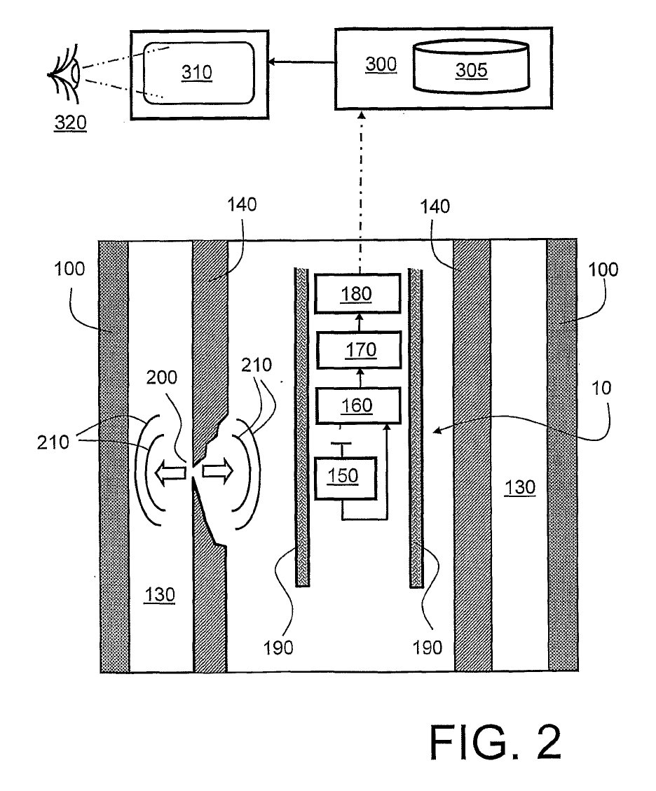

Referring to FIG. 2, a sensor element 150 is implemented as an acoustic transducer including a piezoelectric crystal that is adapted to be placed inside a metal pipe 190; the sensor element 150 and the metal pipe 190 constitute component parts of a logging tool 10. The acoustic transducer is operated in a passive mode, wherein the transducer does not itself emit acoustic signals, but instead detects received acoustic signals 210 arising in operation due to different aforementioned processes occurring within a well 230 down into which the logging tool 10 is lowered during use as illustrated in FIG. 1. All other necessary electronic circuits 160, 170, 180 for processing electronic signals representative of the acoustic signals 210 are also included inside the logging tool 10 itself, so that the sensor element 150 is linked directly to these electronic circuits 160, 170, 180. This logging tool 10 forms a part of a logging string 220, which is lowered down into the well 230 in operation, for example by aid of a wire 20 of the logging string 220. When a leak 200 is active, acoustic noise will be generated in the form of acoustic waves as a result of the flow of fluids through the leak 200; the waves give rise to the aforesaid acoustic signals 210. These fluids may be made up of liquid or gas, or a mixture thereof; moreover, these fluids may also include particles. The acoustic signals 210 include signal energy which is potentially localized in one of more frequency ranges; noise energy having a frequency spectrum in a relatively low frequency range may propagate far greater distances, for example typically in a range of 30 to 70 meters, whereas noise energy having a relatively high frequency spectrum propagates only over very short distances, for example over a propagation distance of less than 1 meter. One or more frequency components of the noise energy will be dependent on the size of the leak 200 and a pressure drop over a barrier through which the leak 200 as arisen and through which flows of liquids, gases, or particles occurs.

During use, the logging string 220 is lead through the well 230 while the sensor element 150 is employed to carry out measurements in a continuous manner, and the leak 200 is thus detected when the logging tool 10 is in close spatial proximity to the leak 200. Such a dynamic positioning of logging string 220, and thereby a physical closeness of the string 220 to the leak 200, enables the tool 10 to be able to both detect very small leaks, as well as to localize these small leaks very precisely. The acoustic noise propagates through a wall of metal pipe 190, and is then subsequently detected by the sensor element 150. On account of the tool 10 employing a so-called passive sensor which does not itself emit interrogating radiation, one may compare a detector mechanism provided by the tool 10 with listening to acoustic waves corresponding to acoustic signals 210, which propagate from a surroundings of the tool 10. By executing experiments for measuring different kinds of background noise, flow noise both with and without liquid, gas and/or particles, and leak noise, it is found that leaks of interest mainly generate acoustic noise at relatively high frequencies, for example in a range of 10 kHz to 1000 kHz, and more preferably in a range of 20 kHz to 1000 kHz, namely in an ultrasonic frequency range. Such high frequency acoustic signals have a relatively short propagation reach, for example in a range of centimetres (cm), that may not be detected by contemporary systems that place their acoustic transducers at a distance of several tens or hundreds of meters away from a possible leak. Thus, the present invention is especially suited for detecting such small leaks on account of the tool 10 being moved in operation in close spatial proximity to the possible leak 200. If no leaks are present, the noise profile experienced when the tool 10 is drawn through the well 230 will be stable, namely dominated by a general noise from a general surroundings of the well 230. Conversely, when an active leak is present, the noise profile will have an increased noise level in specific frequency ranges. This increased noise level in the aforementioned specific frequency ranges may then be observed, for example, on plots presented on a screen or display 310 electrically coupled via a computer 300 to the tool 10; for example, noise levels in the specific frequency ranges may be viewed and interpreted by an operator 320, or interpreted automatically by means of the computer 300 operable to execute suitable signal processing software 305. The signal processing software 305 is beneficially provided on a data carrier which is machine-readable by the computer 300.

The background noise, such as noise from the surroundings and mechanical contact noise that is always present during motion of the tool 10, is in the present invention eliminated by utilizing filtering software installed in a digital signal processor (DSP) 170. Through a telemetry unit 180, a two-way communication between the logging tool 10 and surface logging equipment comprising the computer 300 is established, the operator 320 being located at the corresponding logging equipment. Communication between logging tool 10 and the computer 300 at a surface region occurs via a cable built into the wire 20.

Thus, the software utilized in the DSP 170 is optionally dynamically changed, deleted or overwritten by new software, or new parameters may be input during operation, for example regarding dynamic signal filtering in several frequency ranges, if this should be necessary or desirable for the operator 320. Such dynamic signal filtering may, for example, either be determined manually by the operator 320, or automatically according to signal components present within the signal.

More specifically, a number of frequency bands are chosen and adjusted within which the strength of the received signal is measured, and the result is sent from the tool 10 to the computer 300. The number of frequency bands may be determined prior, during and/or automatically/dynamically. The number of frequency bands and their frequencies is optionally dependent on which signal sources one is desirous to separate at a given instance. Such requirements again depend on what the operator 320 wishes to detect, as well as the acoustic conditions within the pipe 140.

The software for performing signal interpretation in the computer 300 combines the flow of amplitude information for the chosen frequency bands with the position of the tool 10 along the pipe 140, in order to determine the magnitude and position of signal sources of interest disposed along the pipe 140. Such signal sources include, for example, leaks, annular flows on the outside of the pipe 140, or the presence of particles in fluid motion within the pipe 140, or in a region outside the pipe 140.

Every source of acoustic energy, numbered with an index i, of a total of N sources, contributes to the received acoustic effect in each of M frequency bands with index j. The distribution on different frequencies depends on the nature and magnitude of a source to be considered.

The presence and magnitude of different sources may be identified from the received acoustic signal by means of calculations such as, for example, seen by simultaneous equations or artificial networks. Such identification will be elucidated in greater later for example. The received acoustic effect within frequency band j is equal to the sum of the contributions from the N signal sources given in Equation 1 (Eq. 1):

Pⱼ=f_{j,1}s₁+f_{j,2}s₂+ . . . +f_{j,i}sᵢ+ . . . +f_{j,N}s_{N} Eq. 1

Thus, for M frequency bands, a linear equation set may be given as in Equation 2 (Eq. 2):

P=F.s Eq. 2

and in detail as given in Equation 3 (Eq. 3):

$$P = [ \begin{matrix}{P}_{1} \\ {P}_{2} \\ … \\ {P}_{M}\end{matrix} ] , s = [ \begin{matrix}{s}_{1} \\ {s}_{2} \\ … \\ {s}_{N}\end{matrix} ] , F = [ \begin{matrix}{f}_{1 , 1} & … & {f}_{1 , N} \\ … & … & … \\ {f}_{M , 1} & … & {f}_{M , N}\end{matrix} ] \qquad Eq . 3$$

wherein the coefficients may be expressed as in Equation 4 (Eq. 4):

$${f}_{j , i} = \frac{{C}_{j , i} ( {s}_{i} )}{{g}_{j}} \qquad Eq . 4$$

Sⱼ is a number that designates the magnitude of the sound source as measured from the position of the tool 10. In addition gᵢ is an amplification factor that reflects the dependency on frequency in the sensitivity of the tool 10, while the factor C_{i,j} denotes the effect spectrum of the sound source. Generally, the factor C_{i,j} is a function of the dependent factor sⱼ, but for some types of sources the effect spectrum may be approximated as independent from the magnitude of the source, so that the factor C_{j,i} and thus the factor f_{j,i} become constant coefficients.

When the coefficients g_{j,i} are known during the signal processing the equation set may be solved for the indicator sⱼ of the source magnitude. A solution is chosen and the values for sⱼ measured by the tool in various positions is interpreted in order to localize and calculate the magnitude of the signal sources.

The tool 10 is fully digitalized through use of the DSP 170, and thus use of many analogue components such as filters, amplifiers, and other analogue circuits is avoided. The DSP 170 is also equipped with a large so-called flash memory where one loads a portion of the adapted, modular software 305. An important feature of logging tool 10 is that it operates simultaneously in several different frequency bands in the given frequency range. Advantageously, the different frequency bands may be changed dynamically during use of the tool 10. This occurs by initially having a broadband passive acoustic transducer, namely the sensor element 150, which is connected to electronic units of the tool 10, for example the amplifier 160. An output signal from amplifier 160 is then connected with one or more frequency filters that each has a bandwidth that is smaller or equal to that of the transducers, namely the total bandwidth of sensor element 150. High and low pass frequencies for these filters are set digitally from DSP 170, and thus both the bandwidths and center frequencies for these filters may be set by changing the software in the DSP 170. By such an approach, several different types of signal processing are susceptible to being implemented according to need. Such software may comprise signal-processing routines that are suited for suppressing undesired background noise. The background noise may arise from contact between metal and metal, mechanical/structural noise, or electric interference, and is typically difficult to remove. This is also a known problem for other prior acoustic logging tools which are contemporarily commercially available. Use of the DSP 170, for example dynamic changing of the frequency band to signal filtering, enables an optimal signal to noise ratio (namely S/N-ratio) to be attained, something that also is susceptible to contributing to suppression or totally remove the background noise. In a preferred embodiment of the present invention, a single broadband acoustic transducer is utilized for implementing the sensor element 150. Alternatively, use of several transducers simultaneously is also possible pursuant to the present invention, wherein these several transducers have their best sensitivity in mutually different frequency ranges; by use of several transducers, it is feasible to expand the total sensitivity and/or frequency range for the tool 10.

In other prior measuring systems, the above-mentioned parameters, such as the bandwidth to the different filters, are determined by choice of specific electronic components comprising associated static-configuration electronic circuits. When the parameters are chosen in such prior measuring systems, it is not possible to change the filtering characteristics without physically rebuilding a given electronic filter circuit. When the characteristics are susceptible to being digitally dynamically changed, such as in the present invention, for example by changing the software of the DSP 170 and/or the computer 300, this leads to, among other things, that changes may be carried out on the tool 10 when it is currently working down in a well, by sending down new software from the surface to the tool 10 within the well. Thus, signal filtering executed within the tool 10 may be dynamically optimized, thereby rendering it possible to improve the aforementioned S/N ratio, and thereby improving a reliability of the detection of the leak 200.

A clear advantage by being able to change the filter characteristics through changing the above mentioned frequency ranges for signal filtering, is that the different parts of the frequency spectrum of the acoustic signals 210 may be investigated simultaneously. Signal processing in the DSP 170 may be programmed via signal conduction after installation of the tool 10 in the well 230. Thus, the filters in the DSP 170 may be adjusted so that sensor 150 becomes most sensitive in a range where the noise from a single leak 200, operation or flow of gas, fluid, or particles occur at the same time as a different type of noise in the same frequency range is suppressed. This gives an optimal signal-to-noise ratio (S/N-ratio), resulting in a more accurate measurement. Thus, it is possible for the present invention to at least partially solve the previously mentioned technical problem.

Acoustic transducers also include their own inherent internal noise sources, which will arise when they become activated by being powering up, namely energized; such noise includes wide-band thermal noise and shot-noise. The self-generated noise arising in operation in the sensor element 150 is characteristic for each sensor and will show a known pattern after being measured during isolated conditions during production and commissioning of the tool 10. This self-generated noise is independent from the noise due to fluids flowing past the tool 10. When this self-generated noise is characterized, it will simply be able to be eliminated in a later measuring activity, for example by use of suitable signal filtering.

A prominent feature of tool 10 is that it is especially well suited for detecting the high frequency noise of interest that, as a rule, is due to small leaks or flowing of liquid, or gasses, or particles, while the tool 10, or the tool 10 as part of a tool string, is in motion; such motion may either be in “stop/start” steps or continuous as needed for characterizing a well. During other uses, for example when seeking to identify leaks in water pipelines underground, small leaks are not so critical since fluid losses therethrough are little compared to the cost of digging up the pipe and repairing the damage. In oil and gas operation, however, leaks may be critical since aggressive or environmental hostile fluids can escape, and because the high pressures in oil and gas wells may increase the damage over a short time period, for example by way of erosion occurring in perimeter of a leak. As earlier elucidated, the high frequency noise of interest may only propagate over short distances, often shorter than a spatial distance in an order of 1 metre. Such noise signals thus will not be detectable by known technology, where mounted sensor elements are used, since the sensor elements in such instances are mainly placed with a minimum of a couple of tens of metres distance. On account of tools pursuant to the present invention being physically in motion continuously through a region of interest results in leaks being detected down to a spatial precision of, for example, less than 1 cm.

On account of being able to bring the tool 10 is close proximity to a possible leak makes, it becomes possible for the tool 10 and its associated logging apparatus, represented by the computer 300 and its display 310, to detect leaks that generate very weak acoustic noise-like signals. The present invention may, as a consequence of this, detect leaks down to a size range a flow of 1 dl/min of liquids and 0.0001 standard cubic metres of gas per minute. For example, leaks having a flow in a range of 1 to 100 dl/min are susceptible to being detected. Moreover, leaks having a gas flow in a range of 0.0001 to 0.1 standard cubic metres of gas per minute are susceptible to being detected. Since a combined leak flow of liquid and gas may generate noise with an intensity that is higher than the fluids' individually generated noise, the present invention works irrespective of the composition of the leak flow, for example through the hole 200.

In operation, it has been unexpectedly found by the inventors that leaks are more effectively found when the tool 10 is moved continuously down a borehole. If the tool 10 is maintained in a stationary position or moved in a step-wise manner, it is much more difficult, and in some cases impossible, to detect a leak in the pipe 140. If the tool 10 is moved in a step-wise manner, an acoustic signal received by the tool 10 is found to be drastically reduced, for example by 70% or more. Moreover, when the tool 10 is moved continuously past the leak 200, a signal amplitude received by the sensor element 150 reaches a distinct maximum peak as a function of spatial position rather than a gradual Gaussian-type peak. A reason for such a characteristic is not known and is completely unexpected. A size of the leak 200 is susceptible to being computed using a simple formula from knowing a pressure difference ΔP between an inside and outside of the pipe 140 together with a measure of acoustic signal amplitude received at the sensor element 150.

Since the tool 10 is susceptible to being moved freely within the well 230, for example the tool 10 may be moved up and down repeatedly close to a leak point, the tool 10 will detect leaks independently of which direction resulting fluid flows within and around the well 230.

The high sensitivity of the tool 10 pursuant to the present invention enables the tool 10 to detect leaks situated outside an immediate presence of the tool 10, so called secondary leaks. With reference to FIG. 1, one can sense several volumes outside a production pipe 140, in which the tool 10 is situated when in operation. Thus one may, for example, detect leaks over production packing 110 or through a cemented casing pipe 90, 100.

According to another embodiment of the present invention, the acoustic transducer 150 of the logging tool 10 has installed therein a plurality of sensor elements constituting the acoustic transducer 150. Such a configuration for the acoustic transducer 150 provides benefits of enabling various types of leaks to be found more efficiently and accurately. In some cases, a leak as mentioned previously may arise in the casing pipe 190. Thus, a leak may potentially arise from a reservoir 250 and into a casing room between the casing pipe 100 and the production pipe 140. This leak leads to a so-called microflow of fluids in the casing room. Such a flow is not desirable since petroleum fluids escape and a change in the pressure balance in well 230 can arise. Such changes may lead to the occurrence of other leaks as a result of this pressure unbalance. Microflows tend to generate mainly lower frequency acoustic signal components. In such a situation, one may make use of more than merely one acoustic transducer, namely sensor element 150, where these transducers have a narrower bandwidth, and are constructed in order to give maximal sensitivity at lower frequencies.

In one example embodiment of the present invention, the tool 10 and its computer 300 are configured to analyze a signal generated by the sensor element 150 over a relative small number of frequency bands and for a relatively limited number of potential different types of noise sources present near the tool 10. Optionally, one or more of the frequency bends are overlapping as will be elucidated in more detail later. In operation, several samples of the signal are obtained as the tool 10 is moved up or down the well 230.

A mathematical basis and operation of the software 305 executable on the computer 300, together with signal process software loaded into the DSP 170 will now be described. In such a simplified arrangement for computing associated with the tool 10, the aforesaid Equations 1 to 4 (Eqs. 1 to 4) are susceptible to being expressed in an alternative form as will now be elucidated.

The signal from the sensor element 150 can be represented by a signal R_{T}. The signal R_{T} includes numerous Fourier components at various Fourier frequencies ω. By way of example, it is feasible that the tool 10 is brought in a vicinity of a region along the well 230 where there are simultaneously three faults giving rise to four sub-signals as expressed in Equation 5 (Eq. 5):

R_{T}=R₁+R₂+R₃+Rₑₙ Eq. 5

wherein
R₁=a sub-signal due to a leakage of liquid through a leakage hole;
R₂=a sub-signal due to a leakage of gas through a porous leakage region; and
R₃=a sub-signal due to a sand flow through a crack; and
Rₑₙ=a sub-signal corresponding to background noise-generating processes occurring along the well 230 and electronic noise arising in electronic circuits of the tool 10.
   Although Equation 5 (Eq. 5) is sufficiently accurate in many circumstances, when the signals R are uncorrelated noise-like signals, summing of quadratic terms is more appropriate to ensure accuracy as defined by Equation 6 (Eq. 6):

R_{T}²=R₁²+R₂²+R₃²+Rₑₙ² Eq. 6

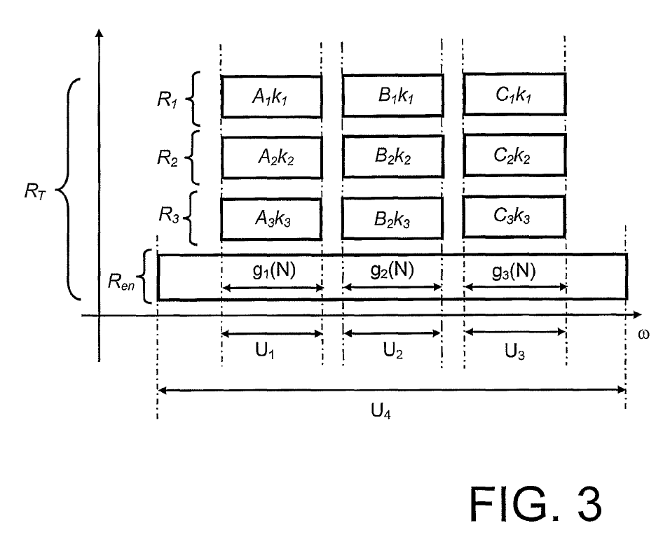

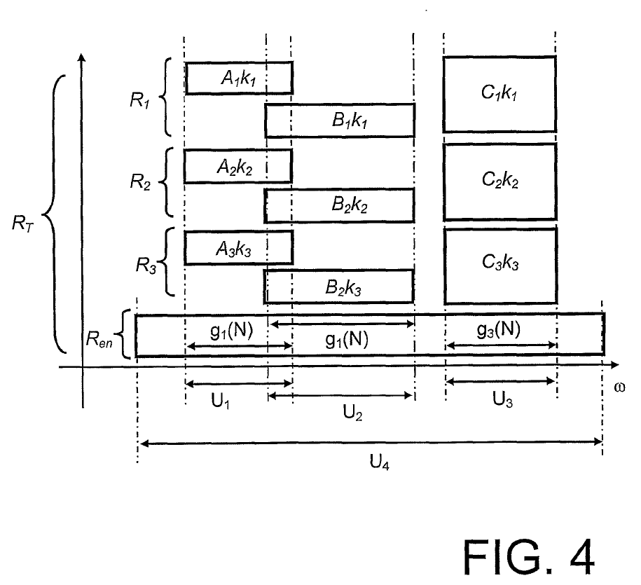

The sub-signals R₁, R₂, R₃ and Rₑₙ have mutually different Fourier components providing these sub-signals with signatures defined in terms of frequencies of their Fourier components and their relative amplitude within each of the sub-signals. In the signal R_{T}, the sub-signals are all present if all three types of fault occur simultaneously in the well 230. Conversely, if no faults are present in the well 230, the signal R_{T} will simple correspond to the sub-signal Rₑₙ. The sub-signal Rₑₙ will depend, for example, whether or not laminar or turbulent fluid streaming is occurring generally within the well 230 whilst the tool 10 is being moved within the well 230. In FIG. 3, there is shown an abscissa axis corresponding to Fourier frequency ω, and an ordinate axis representing the sub-signals wherein the sub-signals R₁ to R₃ are mutually isolated in respect the Fourier frequency ω. Conversely, in FIG. 4, there is shown an abscissa axis corresponding to the Fourier frequency ω and an ordinate axis corresponding to the sub-signals R₁ to R₃ wherein overlap of the sub-signals R₂ and R₃, and also overlap of the sub-signals R₁ and R₂, occurs in the Fourier frequency domain ω. The sub-signals R₁ to R₃ arise on account of physical processes occurring in respect of a particular type of one or more leaks that the sub-signals R₁ to R₃ describe.

Each of the sub-signals R₁ to R₃ themselves comprise, for example, sub-signal components as described substantially by Equations 6 to 9 (Eqs. 6 to 9):

R₁=g₁(A₁k₁)+g₂(B₁k₁)+g₃(C₁k₁) Eq. 6

R₂=g₁(A₂k₂)+g₂(B₂k₂)+g₂(C₂k₂) Eq. 7

R₃=g₁(A₃k₃)+g₂(B₃k₃)+g₃(C₃k₃) Eq. 8

wherein
g₁, g₂, g₃ are functions each generating one or more Fourier frequency component whose amplitude is determined by associated arguments of the functions; for example function g₁ generates a Fourier component at a frequency characteristic of the function g₁ in proportion to its arguments A₁k₁;
k₁, k₂, k₃ are respective magnitudes of first, second and third defects or leaks present in the well 230 respectively; and
A, B, C are shaping coefficients which define a characteristic spectral signature for each type of leak or defect.

In the tool 10, the DSP 170 is operable to divide the signal R_{T} generated by the sensor element 150 by selective band-pass frequency filtering into three band-pass signals U₁ to U₃ providing a representation of signal energy within their respective band-pass bandwidths as provided by Equations 9, 10, and 11 (Eqs. 9 to 11):

U₁=g₁(A₁k₁)+g₁(A₂k₂)+g₁(A₃k₃)+g₁(N) Eq. 9

U₂=g₂(B₁k₁)+g₂(B₂k₂)+g₂(B₃k₃)+g₂(N) Eq. 10

U₃=g₃(C₁k₁)+g₃(C₂k₂)+g₃(C₃k₃)+g₃(N) Eq. 11

wherein g₁(N), g₂(N) and g₃(N) are background noise components as illustrated in FIGS. 3 and 4. A pass-band signal U₄ would include an entirety of the background noise of the tool 10.

To a first approximation, the energy within each band associated with the signals U₁ to U₃ are a summation of each of the sub-signal components to yield corresponding Equations 12, 13 and 14 (Eqs. 12, 13 and 14):

|U₁|=G₁[A₁k₁+A₂k₂+A₃k₃]+N₁ Eq. 12

|U₂|=G₂[B₁k₁+B₂k₂+B₃k₃]+N₁ Eq. 13

|U₃|=G₃[C₁k₁+C₂k₂+C₃k₃]+N₁ Eq. 14

wherein G is a constant coefficient, and noise components N₁, N₂ and N₃ are substantially invariant as the tool 10 is moved up and down the well 230.

On account of the energy associated with the signals U₁ to U₃ being readily computable from filtered signals output from the DSP 170, and the ratios of A₁, B₁ and C₁ being known beforehand for any given type of leak or flow in the well 230, as well as the noise components N₁, N₂ and N₃ and also the coefficients G₁, G₂ and G₃ being invariant, Equations 12, 13 and 14 (Eqs. 12, 13 and 14) are a group of relatively simple simultaneous equations which can be solved in real-time using modest computing resources at the computer 300; for example, proprietary matrix inversion software is susceptible to being employed when operating the computer 300 for such a computation task. Optionally, especially when relatively few terms are included in the simultaneous equations, solving the aforesaid simultaneously equations is beneficially achieved using a pre-computed look-up table or array stored in data memory of the computer 300. Yet alternatively, the computer 300 includes an digital array processor (DAP) configured to perform ultra-fast matrix inversion, thereby enabling the tool 10 to be moved at increased velocity up or down the well 230 in operation whilst simultaneously enabling highly reliable and spatially precise identification of faults and defects to be achieved. When values of components k₁, k₂, k₃ have been computed, the sub-signals R₁, R₂ and R₃ can be generated, for example in graphical form on the display 310 so that the operator 320 is able to immediately identify which type of leak is present for a given position of the tool 10 along the well 230.

For rapid and reliable detection of leaks and similar processes within the well 230, it is found in practice better to employ relatively few frequency bands in the DSP 170 but to take many samples for solving the aforesaid simultaneous equations. Utilizing too many frequency bands and relative few signal samples is susceptible to resulting in computational convergence problems and unreliable detection of smaller faults. Conveniently, the frequency bands are included in a frequency range of 10 kHz to 1000 kHz, more preferably 20 kHz to 1000 kHz. Optionally, the frequency bands employed within the DSP 170 are dynamically modified during measurement using the tool 10 within the well 230.

Although, in reference to FIGS. 3 and 4, a simple and effective implementation of the present invention is described using three filter bands in the DSP 170 with corresponding computations executed in the computer 300, it will be appreciated that more than, or less than, three filter bands are susceptible to being employed in the DSP 170. Optionally, in a range of two to ten band-pass filters are employed in the DSP 170 giving rise to in a range of two to ten filtered signals U for processing in the computer 300. Optionally, the number of filtered signals U employed is dynamically variable. On account of the mutual ratios of the coefficients A, B, C . . . and so on defining which types of leaks or defects are present, an order of three to ten such coefficients enables the tool 10 together with its computer 300 to identify not only magnitudes and spatial positions of leaks and defects, but also accurately characterize their nature. By identifying a nature of the leaks or defects within the well 230, several possibilities derive therefrom, for example:
(a) an identified leak or defect identified in the well 230 is of a stable nature and can be left untreated or unrepaired;
(b) an identified leak or defect identified in the well 230 is of a nature that a repair or component replacement must be executed; such repair can, for example, including extracting and replacing the pipe 140;
(c) an identified leak or defect is of such a serious nature that the well 230 must be temporarily or permanently closed down;
(d) an identified leak or defect is of such a nature that operating conditions of the well 230 should be modified, for example a pressure developed in the well 230 increased or decreased as appropriate to reduce a pressure difference existing across the pipe 140.

Before the tool 10 is capable of being deployed, a calibration method is beneficially invoked. In a first step of the method, a response of the tool 10 to various known leaks or defects in a test pipe is undertaken to determine the coefficients A, B, C and so forth for each type of leak or defect which the tool 10 is required to detect in operation, together with appropriate selection of band-pass filter frequencies for use when configuring the DSP 170. In a second step of the method, a background noise characteristic of the tool 10 is then undertaken in a situation where the tool 10 is disposed remotely from any leaks or defects. In a third step of the method, the computer 300 and the DSP 170 are provided with parameters to configure their filter characteristics and equation coefficients for performing matrix manipulations for detecting different types of leaks, flows and/or defects.

Beneficially, the computer 300 provides a graphical user interface on the screen 310 including a spatial representation of the pipe 140 together with overlaid symbols or markers illustrating a type and/or magnitude of detected leaks or defects. Moreover, the user 310 is able to control positioning of the tool 10 within the well 230 in real time during investigation of the well 230 via controls coupled to the computer 300, for example for allowing the tool 10 to collect more information a preferred locations along the well 230.

Optionally, the tool 10 is supplemented with other types of apparatus, for example one or more of:
(a) inspection cameras and/or optical interrogation probes;
(b) gamma probes;
(c) oil/water/gas phase sensors;
(d) chemical sensors;
(e) pressure sensors;
(f) temperature sensors;
(g) ultrasonic flow sensors;
(h) mechanical flow sensors; and
(g) mechanical “feeler” probes.

These other types of apparatus, as defined in one or more of (a) to (g), are beneficially also mounted onto the tool 10 and their output signals indicative of conditions with the well 230 are conveyed to the computer 300. Moreover beneficially, simultaneous equations solved by the computer 300, as elucidated in the foregoing, also include filtered and/or unfiltered signal components and coefficients pertaining to these other types of apparatus. For example, a certain category of leak is found only to occur when a region within the well 230 has a gas composition at a pressure over a defined pressure threshold.

Expressions such as “has”, “is”, “include”, “comprise”, “consist of”, “incorporates” are to be construed to include additional components or items which are not specifically defined; namely, such terms are to be construed in a non-exclusive manner. Moreover, reference to the singular is also to be construed to also include the plural. Furthermore, numerals and other symbols included within parentheses in the accompanying claims are not to be construed to influence interpreted claim scope but merely assist in understanding the present invention when studying the claims.

Modifications to embodiments of the invention described in the foregoing are susceptible to being implemented without departing from the scope of the invention as defined by the appended claims.

1. A method of quantifying, detecting and localizing one or more leaks or a flow of liquid, gasses, or particles, in an oil or gas producing well (230), wherein said method employs at least one acoustic transducer (150) deployed in operation in the well (230), characterized by that said method comprises steps of:
(a) detecting one or more signals (210) using the at least one acoustic transducer (150), wherein said one or more signals (210) are generated by acoustic noise from one or more leaks (200) or flow of liquid, gasses, or particles in a region surrounding said at least one transducer (150);
(b) amplifying said one or more signals (210) to generate one or more corresponding amplified signals for inputting into a processing unit (170) local to the at least one transducer (150);
(c) filtering said one or more amplified signals (210) over several frequency ranges by utilizing dynamic filtering for improving signal-to-noise ratio by filtering away background noise in said one or more amplified signals (210), thereby generating corresponding filtered data; and
(d) processing said filtered data in said processing unit (170) for transmitting said filtered data to a unit including a computer (300) in a surface region remote from the at least one acoustic transducer for storage and/or viewing of said filtered data, said computer (300) being adapted to perform simultaneous resolution of said filtered data to identify occurrence of said one or more leaks or a flow of liquid, gasses, or particles, in an oil or gas producing well (230).

2. A method as claimed in claim 1, including a step of computing a physical size of said one or more leaks from a pressure difference (a) existing in operation across a wall of a pipe (140) in which said one or more leaks have arisen and an amplitude of said one or more signals (210) provided by said at least one transducer (150).

3. A method as claimed in claim 1 or 2, wherein said filtered data is transmitted at a data rate of up to 1 kbit/second from said processing unit (170) along a wire connection of a string to said computer (300) in the surface region remote from the at least one acoustic transducer (150).

4. A method as claimed in claimed in claim 3, wherein said wire connection is in a range of 3 to 10 km long.

5. A method as claimed in claim 1, wherein said at least one acoustic transducer (150) is mounted inside a sensor housing adapted to be lowered in operation down into said well (230) or a pipe by utilizing a string (20).

6. A method as claimed in claim 1, wherein data collection occurs concurrently with the at least one transducer (150) being moved in a manner of a continuous motion up or down the well (230) or pipe with a log speed in a range of 0.1 to 50 meters per minute.

7. A method as claimed in claim 1, wherein the processing unit (170) is operable to process the one or more amplified signals in real time during data logging.

8. A method as claimed in claim 1, wherein said method is adapted to characterize the well (230) implemented as an injection well for gas and water.

9. A method as claimed in claim 1, wherein said method is adapted to detect and localize a secondary leak, said secondary leak being a leak and flow of gas, liquid, or particles, in a position further out from said well (230), namely in a distantly-positioned casing room.

10. A method as claimed in claim 1, wherein said method is adapted to detect and localize a leak (200) in the well (230) during operation or shutdown of the well (230).

11. A method as claimed in claim 1, wherein said method is adapted to measure small flows of oil, water, or gas, or a combination of these in a casing room close to a position of the at least one acoustic transducers (150).

12. A method as claimed in claim 1, wherein said method is adapted to measure particles in small flows of oil, water, or gas, or a combination of these in a production zone close to a position of the at least one acoustic transducers (150).

13. A method as claimed in claim 1, wherein said method is adapted to implement fluid measurements whilst the well (230) or the pipe is operational or during shutdown.

14. A method as claimed in claim 1, wherein said method involves using a log string or a tool for said at least one transducer (150) that is continuously in motion when in operation in the well (230), or a pipe with log speeds in a range of 0.1 to 50 meters per minute, for carrying out measurements whilst the well (230) or pipe is operational or during shutdown.

15. A system for implementing a method of quantifying, detecting, or localizing one or more leaks or a flow of liquid, gasses, particles in an oil or gas producing well (230), wherein said system includes at least one acoustic transducer (150) arranged in operation in the well (230), characterized by that said system comprises;
(a) a detector operable to detect one or more signals (210) generated by said at least one acoustic transducer (150), wherein said one or more signals (210) are generated in operation by acoustic noise from one or more leaks (200) or flow of liquid, gasses, or particles in a surroundings of said at least one transducer (150);
(b) an amplification device (160) arranged to amplify said one or more signals (210) to generate corresponding one or more amplified signals, said system further comprising a processing unit (170) local to the transducer (150) for processing said one or more amplified signals;
(c) a filtering device associated with said processing unit (170) for dividing said one or more amplified signals (210) over several frequency ranges by applying in operation dynamic filtering, said filtering device being operable to simultaneously detect in said several frequency ranges for enhancing signal-to-noise ratio by filtering away background noise in said one or more amplified signals (210), and thereby generating corresponding processed data; and
(d) a communication link operable to send the processed data from the processing unit (170) to a unit on a surface for storage and/or viewing of said processed data.

16. A system as claimed in claim 15, wherein said system is operable to compute a physical size of said one or more leaks from a pressure difference (ΔP) existing in operation across a wall of a pipe (140) in which said one or more leaks have arisen and an amplitude of said one or more signals (210) provided by said at least one transducer (150).

17. A system as claimed in claim 15 or 16, wherein said filtered data is transmitted at a data rate of up to 1 kbit/second from said processing unit (170) along a wire connection of a string to said computer (300) in the surface region remote from the at least one acoustic transducer (150).

18. A method as claimed in claimed in claim 17, wherein said wire connection is in a range of 3 to 10 km long.

19. A system as claimed in claim 15, wherein said at least one acoustic transducer (150) is mounted inside a sensory housing operable to be lowered or raised in a continuous manner down or up respectively into the well (230) or a pipe whilst being supported from a string (20).

20. A system as claimed in claim 15, wherein the system is operable to collect measurement data when the at least one transducer (150) is continuously moved with a log speed in a range of 0.1 to 50 meter per minute.

21. A system as claimed in claim 15, wherein the processing unit (170) is arranged to carry out adaptive data processing in real time.

22. A system as claimed in claim 15, wherein the system is configured for the well (230) implemented as an injection well for gas and water.

23. A system as claimed in claim 15, wherein the system is operable to detect and localize a secondary leak, said secondary leak being a leak and flow of gas, liquid, or particles, in a position further out in a well construction, in a distant casing room.

24. A system as claimed in claim 15, wherein the system is operable to detect and localize a leak (200) in a well (230) whilst the well (230) is operational or during shutdown.

25. A system as claimed in claim 15, wherein the system is operable to measure small flows of oil, water, or gas, or a combination of these in a casing room in proximity of a position of the at least one transducer (150).

26. A system as claimed in claim 15, wherein the system is operable to measure small flows of oil, water, or gas, or a combination of these in a production zone in proximity of a position of the at least one transducer (150).

27. A system as claimed in claim 20, wherein the system is operable to implement flow measurements while the well (230) or pipe is operational or during shutdown.

28. A system as claimed in claim 15, wherein the system is arranged to use a log string or a tool for the at least one transducer (150), said log string being adapted for being in a continuous motion in a well (230), or in a pipe with log speeds in a range of 0.1 to 50 meters per minute, said system being operable to implement measurements whilst the well (230) or pipe is operational or during shutdown.

29. A software product (305) recorded on a machine-readable data carrier, said software product (305) being executable on computing hardware (300) in connection with implementing a method as claimed in claim 1.

30. A software product recorded on a machine-readable data carrier, said software product being executable on digital signal processing hardware (170) for processing one or more signals, said software product being executable on said signal processing hardware (170) in connection with implementing a method as claimed in claim 1.
